(19) United States
(12) Patent Application Publication
(10) Pub. No.: US 2020/0133371 A1
(43) Pub. Date: Apr. 30, 2020

(54) SYSTEM PERFORMANCE CONTROL DEVICE AND METHOD

(71) Applicant: Wistron Corp., New Taipei City (TW)

(72) Inventors: Ying Tzu CHOU, New Taipei City (TW); Chin-Min LIU, New Taipei City (TW); Wen-Cheng HSU, New Taipei City (TW)

(21) Appl. No.: 16/276,450

(22) Filed: Feb. 14, 2019

(30) Foreign Application Priority Data
Oct. 30, 2018 (TW) 107138279

(51) Int. Cl. G06F 1/3212; G06F 1/324; G06F 1/3234

(52) U.S. Cl. CPC G06F 1/3212; G06F 1/3278; G06F 1/3265; G06F 1/324

(57) ABSTRACT

A system performance control device is provided. The system performance control device includes a battery and a controller. The controller is coupled to the battery to obtain battery information from the battery. When the controller detects that the battery capacity of the battery is at a first level according to the battery capacity information, the controller adjusts system performance of the system performance control device to a first setting value. When the controller detects that the battery capacity of the battery is at a second level according to the battery capacity information, the controller adjusts the system performance of the system performance control device to a second setting value, wherein the first level is greater than the second level, and the first setting value is higher than the second setting value.

### CROSS REFERENCE TO RELATED APPLICATIONS

This application claims priority of TW Patent Application No. 107138279 filed on Oct. 30, 2018, the entirety of which is incorporated by reference herein.

### BACKGROUND OF THE INVENTION

### Field of the Invention

The invention generally relates to system performance controlling technology, and more particularly, to system performance controlling technology for instantaneously controlling system performance according to battery capacity.

### Description of the Related Art

As technology progresses, users are increasingly required to operate electronic devices in a high-performance state.

When an electronic device is operated in a high-performance state, the electronic device may consume more battery power. Therefore, traditionally, in order to avoid using the battery in the over-current condition, the discharge capability of the battery may be limited. For example, when a battery is designed for the operations corresponding to different system performances of the electronic device, different maximum-discharge-current protections for the battery will be set. However, when the electronic device is continuously operated in a high-performance state, the battery may shut down to achieve the maximum-discharge-current protection, even if the battery capacity still has not reached the lowest level. Therefore, the battery life will be influenced.

### BRIEF SUMMARY OF THE INVENTION

A system performance control device and method for controlling the system performance instantaneously according to the battery capacity are provided to overcome the problems mentioned above.

An embodiment of the invention provides a system performance control device. The system performance control device includes a battery and a controller. The controller is coupled to the battery to obtain battery information from the battery. When the controller detects that the battery capacity of the battery is at a first level according to the battery capacity information, the controller adjusts system performance of the system performance control device to a first setting value. When the controller detects that the battery capacity of the battery is at a second level according to the battery capacity information, the controller adjusts the system performance of the system performance control device to a second setting value, wherein the first level is greater than the second level, and the first setting value is higher than the second setting value.

An embodiment of the invention provides a system performance controlling method. The system performance controlling method is applied to a system performance control device. The system performance controlling method includes the steps of obtaining battery information from a battery of the system performance control device; adjusting system performance of the system performance control device to a first setting value in response to the battery capacity of the battery is at a first level according to the battery capacity information; and adjusting the system performance to a second setting value in response to the battery capacity of the battery is at a second level according to the battery capacity information, wherein the first level is greater than the second level, and the first setting value is higher than the second setting value.

Other aspects and features of the invention will become apparent to those with ordinary skill in the art upon review of the following descriptions of specific embodiments of system performance control devices and methods.

### BRIEF DESCRIPTION OF THE DRAWINGS

The invention will become more fully understood by referring to the following detailed description with reference to the accompanying drawings, wherein:

FIG. 1 is a block diagram of a system performance control device 100 according to an embodiment of the invention;

FIG. 2 is a flow chart 200 illustrating a system performance controlling method according to an embodiment of the invention.

### DETAILED DESCRIPTION OF THE INVENTION

The descriptions of the invention are some embodiments for the purpose of illustrating the general principles of the invention and should not be configured to limit the invention. The scope of the invention is determined by reference to the appended claims.

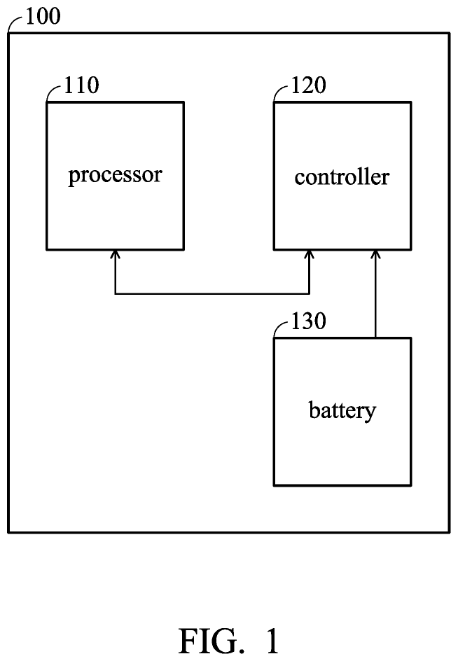

FIG. 1 is a block diagram of a system performance control device 100 according to an embodiment of the invention. According to an embodiment of the invention, the system performance control device 100 may be a mobile phone, a tablet, a desktop computer, a note book, and so on. As shown in FIG. 1, the system performance control device 100 may include a processor 110, a controller 120 and a battery 130. It should be noted that, FIG. 1 presents a simplified block diagram in which only the elements relevant to the embodiment of the invention are shown. However, the invention should not be limited to what is shown in FIG. 1. The system performance control device 100 also can comprise other elements.

According to an embodiment of the invention, the processor 110 may be a central processing unit (CPU). According to an embodiment of the invention, the controller 120 may be an embedded controller (EC). The controller 120 may be coupled to the processor 110 and the battery 130. Furthermore, the controller 120 may be coupled to the input/output (I/O) connection ports (not shown in figures) of the system performance control device 100, and coupled to the devices, such as a keyboard, a mouse, a display and a fan, through the I/O connection ports to control the devices.

According to an embodiment of the invention, the controller 120 may obtain the battery capacity information from the battery 130, and adjust the whole system performance of the system performance control device 100 according to the battery capacity information of the battery 130. Specifically, as the battery 130 discharges continuously, the controller 130 may hierarchically reduce the whole system performance of the system performance control device 100 according to the current battery capacity information of the battery 130.

For example, when the controller 120 knows (or detects) that the battery capacity of the battery 130 is at a first level (e.g. 100%˜50%) according to the battery capacity information, the controller 120 may adjust the whole system performance of the system performance control device 100 to a first setting value (i.e. the system performance control device 100 can be operated in the highest system performance) corresponding to the first level. Then, during the discharging time of the battery 130, the controller 120 may continuously obtain the battery capacity information corresponding to the battery 130. When the controller 120 detects that the battery capacity of the battery 130 decreases to a second level (e.g. 50%˜40%) according to the battery capacity information, in order to avoid the protection mechanism of the battery 130 is activated because the system performance control device 100 is still operated in the system performance corresponding to the first setting value (i.e. if the system performance control device 100 maintains to be operated in the system performance corresponding to the first setting value, the battery 130 may achieve the maximum-discharge-current, as a result, the battery 130 will be shut down to protect the battery 130), the controller 120 may adjust the whole system performance of the system performance control device 100 to a second setting value corresponding to the second level. When the controller 120 knows that the battery capacity of the battery 130 decreases to a third level (e.g. 40%˜30%) according to the battery capacity information, in order to avoid the protection mechanism of the battery 130 is activated because the system performance control device 100 is still operated in the system performance corresponding to the second setting value, the controller 120 may adjust the whole system performance of the system performance control device 100 to a third setting value corresponding to the third level. When the controller 120 knows that the battery capacity of the battery 130 decreases to a fourth level (e.g. 30%˜20%) according to the battery capacity information, in order to avoid the protection mechanism of the battery 130 is activated because the system performance control device 100 is still operated in the system performance corresponding to the third setting value, the controller 120 may adjust the whole system performance of the system performance control device 100 to a fourth setting value corresponding to the fourth level. When the controller 120 knows that the battery capacity of the battery 130 decreases to a fifth level (e.g. 20%˜10%) according to the battery capacity information, in order to avoid the protection mechanism of the battery 130 is activated because the system performance control device 100 is still operated in the system performance corresponding to the fourth setting value, the controller 120 may adjust the whole system performance of the system performance control device 100 to a fifth setting value corresponding to the fifth level. When the controller 120 knows that the battery capacity of the battery 130 decreases to a sixth level (e.g. 10%˜0%) according to the battery capacity information, in order to avoid the protection mechanism of the battery 130 is activated because the system performance control device 100 is still operated in the system performance corresponding to the fifth setting value, the controller 120 may adjust the whole system performance of the system performance control device 100 to a sixth setting value corresponding to the sixth level. Therefore, according to the above operations, the controller 120 may continuously adjust the whole system performance of the system performance control device 100 until the battery capacity of the battery 130 has decreased to the lowest level (e.g. 10%˜0%). In addition, it should be noted that the above example is only for illustrating the embodiment of the invention, but the invention should not be limited thereto.

According to an embodiment of the invention, the related setting information of the setting values (i.e. the whole system performance of the system performance control device 100) corresponding to different battery capacity levels of the battery 130 may be stored in a storage device (not shown in figures) previously. The controller 120 may adjust the setting values according to the stored setting information. It should be noted that different batteries may have different specifications. Therefore, the battery capacity levels of each battery and the setting information corresponding to the battery capacity levels of each battery may be different according to the different specifications of the batteries.

In the embodiment of the invention, the controller 120 may adjust the whole system performance of the system performance control device 100 by enabling or disabling different elements of the system performance control device 100 or by adjusting settings for the elements of the system performance control device 100. Details will be discussed in the embodiments below, but the invention should not be limited to the methods provided in the embodiments below.

According to an embodiment of the invention, the controller 120 may adjust the whole system performance of the system performance control device 100 by adjusting the power setting of the processor 110. For example, when the battery capacity of the battery 130 is at a first level (e.g. 100%˜50%), because the battery capacity of the battery 130 is still sufficient, the processor 110 can be operated in a higher performance (or high power) state (e.g. the processor 110 is operated in the power-level 4 (PL4) state). When the battery capacity of the battery 130 decreases to a second level (e.g. 50%˜40%), the controller 120 may notify the processor 100 of that the processor 100 needs to decrease its performance (e.g. the processor 110 changes to be operated in the power-level 3 (PL3) state) to avoid the protection mechanism of the battery 130 is activated.

According to an embodiment of the invention, the controller 120 may adjust the whole system performance of the system performance control device 100 by adjusting the backlight brightness of a backlight module (not shown in figures). For example, when the battery capacity of the battery 130 is at a first level (e.g. 100%˜50%), because the battery capacity of the battery 130 is still sufficient, the system performance control device 100 can be operated in a high-performance state. When the battery capacity of the battery 130 decreases to a second level (e.g. 50%˜40%), the controller 120 may decrease the backlight brightness of the backlight module to reduce the whole current of the system performance control device 100 (i.e. decreasing the whole system performance of the system performance control device 100) to avoid the protection mechanism of the battery 130 is activated.

According to an embodiment of the invention, the controller 120 may adjust the whole system performance of the system performance control device 100 by disabling one or more connection ports (e.g. USB connection ports). For example, when the battery capacity of the battery 130 is at a first level (e.g. 100%˜50%), because the battery capacity of the battery 130 is still sufficient, the system performance control device 100 can be operated in a high-performance state. When the battery capacity of the battery 130 decreases to a second level (e.g. 50%˜40%), the controller 120 may disable an USB connection port to reduce the whole current of the system performance control device 100 (i.e. decreasing the whole system performance of the system performance control device 100) to avoid the protection mechanism of the battery 130 is activated.

According to an embodiment of the invention, the controller 120 may adjust the whole system performance of the system performance control device 100 by adjusting the data access speed of the system performance control device 100. For example, when the battery capacity of the battery 130 is at a first level (e.g. 100%˜50%), because the battery capacity of the battery 130 is still sufficient, the system performance control device 100 can be operated in a high-performance state. When the battery capacity of the battery 130 decreases to a second level (e.g. 50%˜40%), the controller 120 may reduce the data access speed of the system performance control device 100 to reduce the whole current of the system performance control device 100 (i.e. decreasing the whole system performance of the system performance control device 100) to avoid the protection mechanism of the battery 130 is activated.

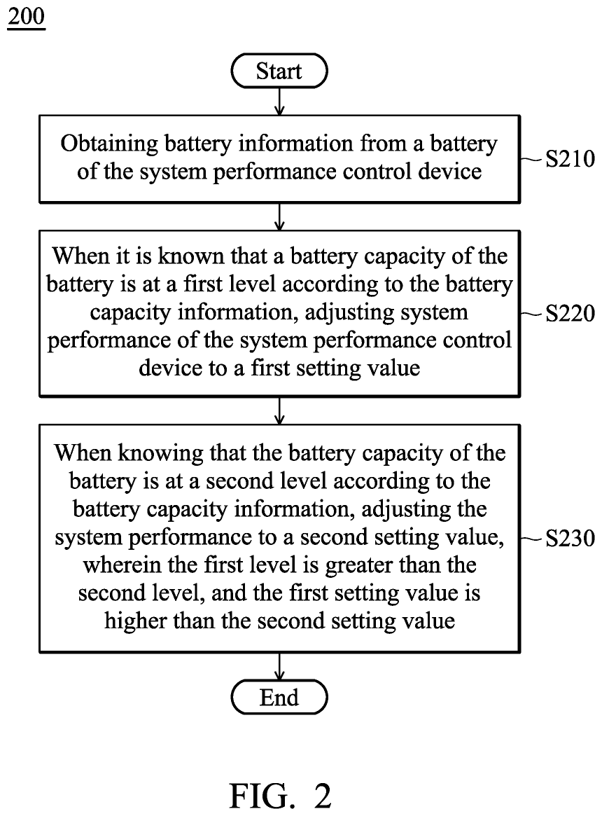

FIG. 2 is a flow chart 200 illustrating a system performance controlling method according to an embodiment of the invention. The system performance controlling method can be applied to the system performance control device 100. As shown in FIG. 2, in step S210, a controller of the system performance control device 100 may continuously obtain battery capacity information of a battery. In step S220, when the controller detects that the battery capacity of the battery is at a first level according to the battery capacity information, the controller may adjust the system performance of the system performance control device 100 to a first setting value. In step S230, when the controller knows that the battery capacity of the battery is at a second level according to the battery capacity information, the controller may adjust the system performance of the system performance control device 100 to a second setting value, wherein the first level is greater than the second level, and the first setting value is higher than the second setting value. Accordingly, the controller may continuously adjust the whole system performance of the system performance control device 100 until the battery capacity of the battery has decreased to the lowest level.

According to an embodiment of the invention, the system performance controlling method further includes that the controller may adjust the whole system performance of the system performance control device 100 by adjusting the backlight brightness of a backlight module.

According to an embodiment of the invention, the system performance controlling method further comprises that the controller may adjust the whole system performance of the system performance control device 100 by disabling one or more connection ports.

According to an embodiment of the invention, the system performance controlling method further includes that the controller may adjust the whole system performance of the system performance control device 100 by adjusting the power setting of the processor of the system performance control device 100.

According to an embodiment of the invention, the system performance controlling method further includes that the controller may adjust the whole system performance of the system performance control device 100 by adjusting the data access speed of the system performance control device 100.

According to embodiments of the system performance controlling method, the system performance control device 100 can control the system performance instantaneously according to the battery capacity of the battery. Therefore, the battery life will be increased. In addition, according to embodiments of the system performance controlling method, in order to increase the battery life, the user will not operate the electronic device in the low system performance all the time.

Use of ordinal terms such as “first”, “second”, “third”, etc., in the disclosure and claims is for description. It does not by itself connote any order relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A system performance control device, comprising:
a battery; and
a controller, coupled to the battery to obtain battery information from the battery;
wherein when the controller detects that a battery capacity of the battery is at a first level according to the battery capacity information, the controller adjusts system performance of the system performance control device to a first setting value, and when the controller detects that the battery capacity of the battery is at a second level according to the battery capacity information, the controller adjusts the system performance of the system performance control device to a second setting value, and
wherein the first level is greater than the second level, and the first setting value is higher than the second setting value.

2. The system performance control device of claim 1, wherein the controller adjusts the system performance by adjusting a backlight brightness of a backlight module of the system performance control device.

3. The system performance control device of claim 1, wherein the controller adjusts the system performance by disabling one or more connection ports of the system performance control device.

4. The system performance control device of claim 1, wherein the controller adjusts the system performance by adjusting a power setting of a processor of the system performance control device.

5. The system performance control device of claim 1, wherein the controller adjusts the system performance by adjusting data access speed of the system performance control device.

6. A system performance controlling method, applied to a system performance control device, and comprising:
obtaining battery information from a battery of the system performance control device;
adjusting system performance of the system performance control device to a first setting value, in response to a battery capacity of the battery is at a first level according to the battery capacity information; and
adjusting the system performance to a second setting value in response to the battery capacity of the battery is at a second level according to the battery capacity information,
wherein the first level is greater than the second level, and the first setting value is higher than the second setting value.

7. The system performance controlling method of claim 6,
wherein the system performance is adjusted by adjusting a backlight brightness of a backlight module of the system performance control device.

8. The system performance controlling method of claim 6,
wherein the system performance is adjusted by disabling one or more connection ports of the system performance control device.

9. The system performance controlling method of claim 6,
wherein the system performance is adjusted by adjusting a power setting of a processor of the system performance control device.

10. The system performance controlling method of claim 6,
wherein the system performance is adjusted by adjusting data access speed of the system performance control device.
